(19) United States
(12) Patent Application Publication
(10) Pub. No.: US 2024/0187700 A1
(43) Pub. Date: Jun. 6, 2024

(54) METHODS AND SYSTEMS OF CRYPTOCURRENCY AWARDS WITH A GUESSING VIDEO FUNCTIONALITY IN AN INTERACTIVE SHORT-VIDEO PLATFORM

(71) Applicant: SHADMAN SAKIB, dubai (AE)

(72) Inventor: SHADMAN SAKIB, dubai (AE)

(21) Appl. No.: 18/102,083

(22) Filed: Jan. 27, 2023

Related U.S. Application Data
(63) Continuation-in-part of application No. 18/075,687, filed on Dec. 6, 2022.
(63) Continuation-in-part of application No. 18/090,495, filed on Dec. 29, 2022, now abandoned.

(51) Int. Cl. H04N 21/4784; H04N 21/2743; H04N 21/475

(52) U.S. Cl. CPC H04N 21/4784; H04N 21/2743; H04N 21/4756; H04N 21/4758

(57) ABSTRACT

In one aspect, a computerized method for cryptocurrency management in an interactive video platform utilizing a guessing video comprising: providing an interactive video platform, wherein the interactive video platform comprises an online video hosting services and an online video sharing service; enabling a user to upload the guessing video to the interactive video platform, wherein the guessing video comprises a video that includes a timestamp, wherein the time stamp causes a popup display, wherein the popup display comprises a question and an input graphical user interface, and wherein a viewer enters an answer to the question using the input graphical user; determining that the viewer has input the correct answer; and awarding the viewer a specified number of points allotted and managed by the an online video sharing service.

### CLAIM OF PRIORITY

This application claims priority to and is a continuation in part of U.S. patent application Ser. No. 18/075,687, filed on 6 Dec. 2022 and titled METHODS AND SYSTEMS OF CRYPTOCURRENCY MANAGEMENT IN AN INTERACTIVE SHORT-VIDEO PLATFORM. This patent application is hereby incorporated by reference in its entirety.

This application claims priority to and is a continuation in part of U.S. patent application Ser. No. 18/090,495, filed on 29 Dec. 2022 and titled METHODS AND SYSTEMS OF CRYPTOCURRENCY AWARDS FOR INDIRECT PARTICIPATION IN AN INTERACTIVE SHORT-VIDEO PLATFORM. This patent application is hereby incorporated by reference in its entirety.

### BACKGROUND

### 1. Field

This application relates generally to online video sharing, and more particularly to a system, method and article of cryptocurrency awards for cryptocurrency awards with a guessing video functionality in an interactive short-video platform.

### 2. Related Art

In an online environment, an enterprise can provide question and answer (QA) services. However, due to the large number of questions and answers provides, manual QA services for customer service can tedious, labor intensive, prone to errors and costly. For example, only 1% of emails, chats, and phone engagements are audited. This can deliriously affect metrics, agent sentiment and customer satisfaction. Accordingly, improvements are desired that combine the best of human and artificial intelligence to create an automated, proactive QA process and improve agent and customer experience in real time.

### SUMMARY OF THE INVENTION

In one aspect, a computerized method for cryptocurrency management in an interactive video platform utilizing a guessing video comprising: providing an interactive video platform, wherein the interactive video platform comprises an online video hosting services and an online video sharing service; enabling a user to upload the guessing video to the interactive video platform, wherein the guessing video comprises a video that includes a timestamp, wherein the time stamp causes a popup display, wherein the popup display comprises a question and an input graphical user interface, and wherein a viewer enters an answer to the question using the input graphical user; determining that the viewer has input the correct answer; and awarding the viewer a specified number of points allotted and managed by the an online video sharing service.

### BRIEF DESCRIPTION OF THE DRAWINGS

FIG. 1 illustrates an example system used for cryptocurrency management in an interactive short-video platform, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example short-video management server(s), according to some embodiments.

FIG. 5 illustrates an example incentivization process for a cryptocurrency management in an interactive short-video platform, according to some embodiments.

FIG. 6 illustrates can example process for awarding cryptocurrency points in an interactive short-video platform, according to some embodiments.

FIG. 7 illustrates an example process for implementing interactive short-video, according to some embodiments.

FIG. 8 illustrates an example process for cryptocurrency awards for indirect participation in an interactive short-video platform, according to some embodiments.

FIG. 9 illustrates another example process utilized herein, according to some embodiments.

FIG. 10 illustrates an example process for implementing cryptocurrency awards for indirect participation in an interactive short-video platform, according to some embodiments.

FIG. 11 illustrates an example process for implementing a cryptocurrency awards with a guessing video functionality in an interactive short-video platform, according to some embodiments.

FIG. 12 illustrates another example process for managing a ‘guessing video’ functionality on a video sharing website, according to some embodiments.

The Figures described above are a representative set and are not an exhaustive with respect to embodying the invention.

### DESCRIPTION

Disclosed are a system, method, and article of manufacture for cryptocurrency awards with a guessing video functionality in an interactive short-video platform. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Cryptocurrency can be a digital currency designed to work as a medium of exchange through a computer network that is not reliant on any central authority, such as a government or bank, to uphold or maintain it. Cryptocurrency can be a decentralized system for verifying that the parties to a transaction have the money they claim to have, eliminating the need for traditional intermediaries, such as banks, when funds are being transferred between two entities. Individual coin ownership records are stored in a digital ledger, which is a computerized database using strong cryptography to secure transaction records, to control the creation of additional coins, and to verify the transfer of coin ownership.

Digital currency can be any currency, money, or money-like asset that is primarily managed, stored or exchanged on digital computer systems, especially over the internet. Types of digital currencies can include, inter alia: cryptocurrency, virtual currency and central bank digital currency. Digital currency can be recorded on a distributed database on the internet, a centralized electronic computer database owned by a company or bank, within digital files or even on a stored-value card.

Digital wallet (e.g. an e-wallet, etc.) is an electronic device, online service and/or software program that allows one party to make electronic transactions with another party bartering digital currency units for goods and services. This can include purchasing items either online or at the point of sale in a brick-and-mortar store, using either mobile payment (e.g. on a smartphone or other mobile device) or (e.g. for online buying only) using a laptop or other personal computer.

Distributed ledger is the consensus of replicated, shared, and synchronized digital data that is geographically spread (distributed) across many sites, countries, or institutions. In contrast to a centralized database, a distributed ledger does not require a central administrator, and consequently does not have a single (e.g. central) point-of-failure.

Mobile device can include a handheld computing device that includes an operating system (OS), and can run various types of application software, known as apps. Example handheld devices can also be equipped with various context sensors (e.g. biosensors, physical environmental sensors, etc.), digital cameras, Wi-Fi, Bluetooth, and/or GPS capabilities. Mobile devices can allow connections to the Internet and/or other Bluetooth-capable devices, such as an automobile, a wearable computing system and/or a microphone headset. Exemplary mobile devices can include smart phones, tablet computers, optical head-mounted display (OHMD), virtual reality head-mounted display, smart watches, other wearable computing systems, etc.

Online video platform provided by a video hosting service, enables users to upload, convert, store and play back video content on the Internet, often via a structured, large-scale system that may generate revenue. Users can upload video content via the hosting service's website, mobile or desktop application, or other interfaces (API). An online video platform can include a video hosting website, video-sharing website, other media hosting/sharing websites, etc.

Social graph is a graph that represents social relations between entities.

Social networking service can be an online platform which people use to build social networks or social relationships with other people who share similar personal or career content, interests, activities, backgrounds or real-life connections.

Software as a service (SaaS) is a software licensing and delivery model in which software is licensed on a subscription basis and is centrally hosted. SaaS is also known as on-demand software and Web-based/Web-hosted software.

Web3 is an idea for a new iteration of the World Wide Web which incorporates concepts such as decentralization, blockchain technologies, and token-based economics.

The subject matter of the present definitions can be utilized in example embodiments of the following systems and processes.

### Example Computer Architecture and Systems

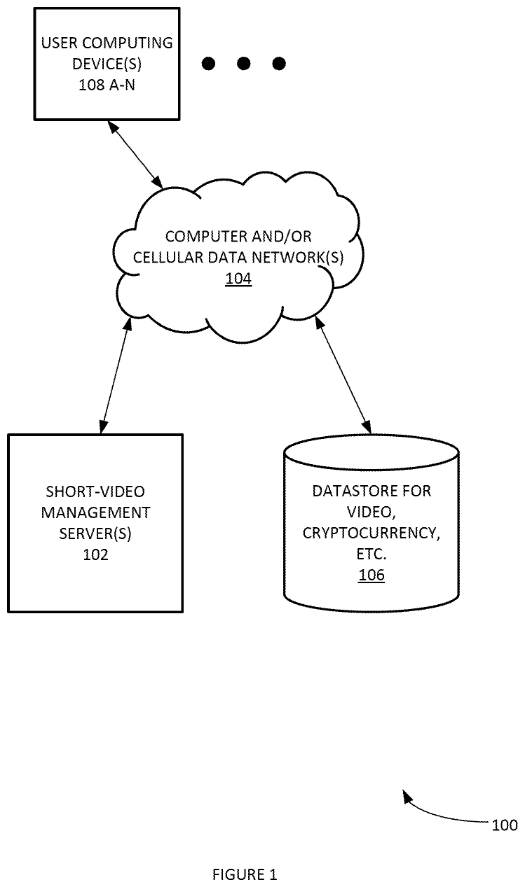

FIG. 1 illustrates an example system 100 used for cryptocurrency management in an interactive short-video platform, according to some embodiments. System 100 can use digital wallets, distributed ledgers, blockchains, social networking service analysis systems, AI/ML systems, etc.

System 100 can provide/manage a user-vs-user challenge (e.g. a ‘Vs challenge’). In a user-vs-user challenge, users can create an against challenge in which a user challenges other public users. These users can be social networking connections (e.g. friends, followers, etc.) to participate. These participants (e.g. other public users, friends) can accept challenges and create a video against the challenge video and post it hence. The other users (e.g. excluding participators) can take various actions. These can include, inter alia: reviewing the videos and provide ratings, share the video and comments to participator individually. Short video management module/online video platform 102 includes functionalities for implementing these actions. Based on a unique rating system and some other factors too, the Vs challenge winner announced in a configurable period of time (e.g. twenty-four hours after completion of the Vs challenge, etc.). Various details of the Vs challenge can be based on the creator/user profile.

The Vs challenge winner will earn cryptocurrency points as an incentive which is eventually converted to a specified cryptocurrency (e.g. a VURSE cryptocurrency, etc.). The Vs challenge creators earn points when their videos are challenged by other users to a certain number those points can be converted into cryptocurrency. This can be managed by short video management module/online video platform 102.

User computing device(s) 108 A-N can be used make, edit, watch and/or upload video content to short video management module/online video platform 102. This can be done via computer and/or cellular data network(s) 104 (e.g. can include the Internet, etc.). Short-video management server(s) 102 can implement processes 500-700. Datastore 106 can store user profiled/actions, video, challenge data, points data, crypto-currency data, etc.

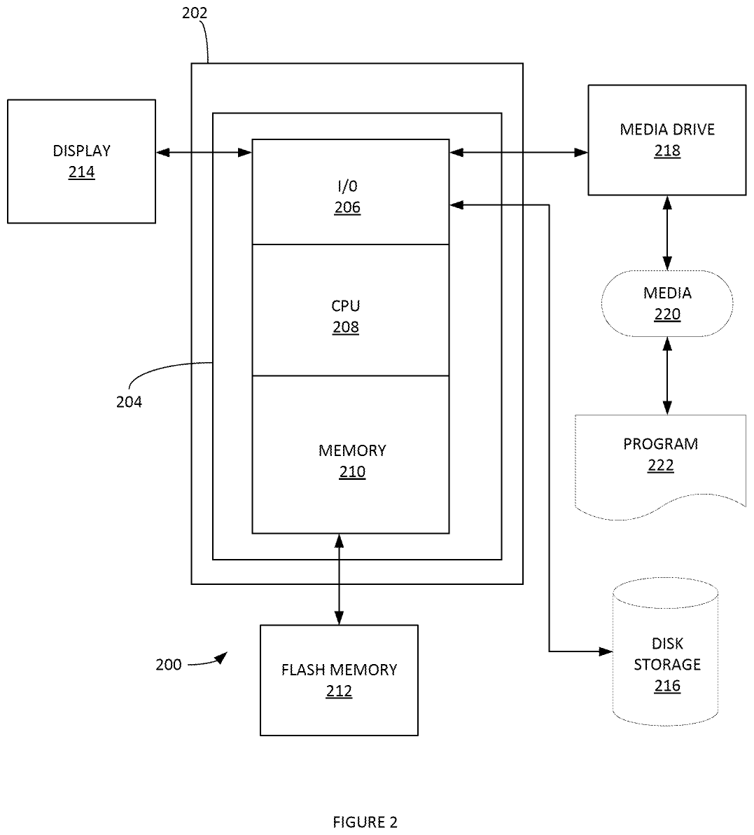

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

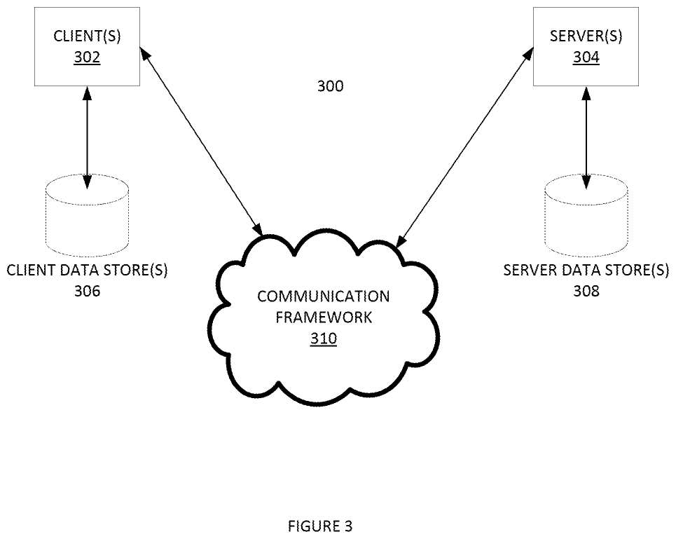

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

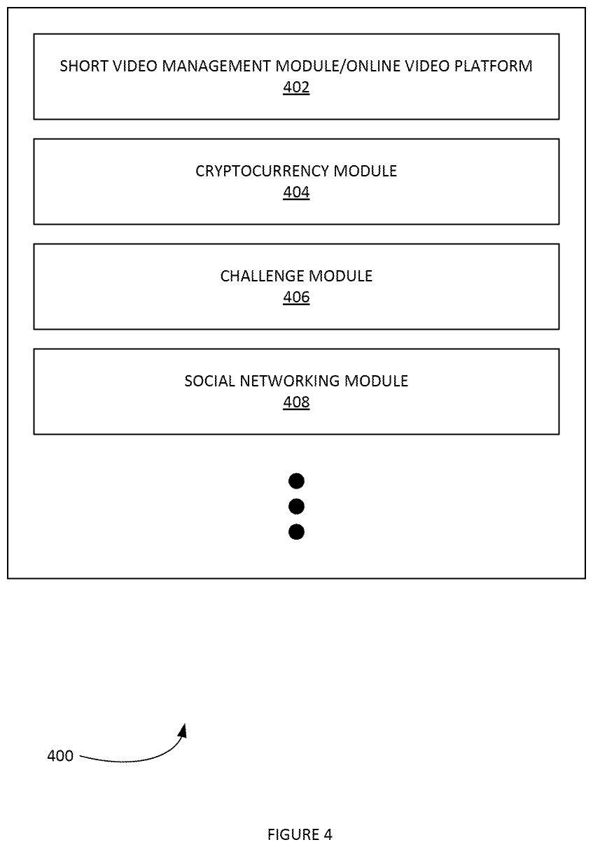

FIG. 4 illustrates an example short-video management server(s) 400, according to some embodiments. Short-video management server(s) 400 can operate as short-video management server(s) 102 in whole or in part.

Short video management module/online video platform 402 can provide an online video platform (OVP). ort video management module/online video platform 402 can provide/manage a video hosting service. This can enable users to upload, convert, store and play back video content on the Internet, via a structured, large-scale server-side system. Users (e.g. using user computing device(s) 108 A-N, etc.) can upload video content via the hosting service's website, mobile or desktop application, or other interfaces (API). The type of video content uploaded can include, inter alia: shorts to full-length TV shows and movies. Short video management module/online video platform 402 can be a video host stores the video on its server and offers users the ability to enable different types of embed codes or links that allow others to view the video content. This can be implemented via a dashboard provided by short video management module/online video platform 402 (e.g. on a website and/or mobile-device application, etc.). Short video management module/online video platform 402 provide a video hosting website, video-sharing website, etc. Accordingly, short video management module/online video platform 402 can include web servers, search engines, NLP functionalities, ML/AI functionalities for analysis user searches, video content (e.g. identify and label video based on audio/video content, etc.), and the like. Short video management module/online video platform 402 can be accessed via computer and/or cellular data network(s) 104.

Cryptocurrency module 404 can enable users to trade awarded points (e.g. cryptocurrency points, etc.) for a specified cryptocurrency. In some embodiments, another digital currency other than a cryptocurrency can be utilized. Cryptocurrency module 404 can store individual coin ownership records in a digital ledger. This can be a computerized database using strong cryptography to secure transaction records, to control the creation of additional coins, and to verify the transfer of coin ownership. This can be a distributed ledger, sometimes called a shared ledger, is a consensus of replicated, shared, and synchronized digital data geographically spread across multiple sites, countries, and/or institutions.

Challenge module 406 can manage various challenges (e.g. Vs challenge, etc.) described herein. Challenge module 406 can implement processes 500-900 with the various systems/functionalities provided herein.

Challenge module 406 can also enable user who do not participate in the video challenges to guess/predict winners of video challenges. Cryptocurrency module 404 can then provide points/cryptocurrency based on the success of the guess/predictions. In one example, feature is specific to boost users' crypto economy by allowing them to become a Vs challenge indirect participator. The users who are not participating (e.g. accepting challenge and creating video) in Vs challenge but still can participate by guessing ‘Who will win’ the Vs challenge. These users can predict the winner before its Vs challenge result gets announced. If users guessing is correct then they will earn VURSE points which eventually be converted to VURSE cryptocurrency.

Social networking module 408 can manage a social graph the users of short video management module/online video platform 402. Social networking module 408 can notify other users when a challenge is created. This notification can be performed based on the placement and/or proximity of the various users with respect to the initial challenging user in the social graph. Other users can also be notified based on the content of the video. Other users can also be notified based on tagging by the user and/or other users as well. Social networking module 408 can manage a social network graph of users and their respective connections.

As noted supra, short video management module/online video platform 402 can include various other systems not shown, including: text messaging servers, electronic mail servers, language processing/analysis servers, video content analysis servers, database management systems (e.g. to manage the content of videos, user profiles/actions, cryptocurrency ledgers, etc.). This data store 106 that store videos, cryptocurrency, etc.

### Example Methods

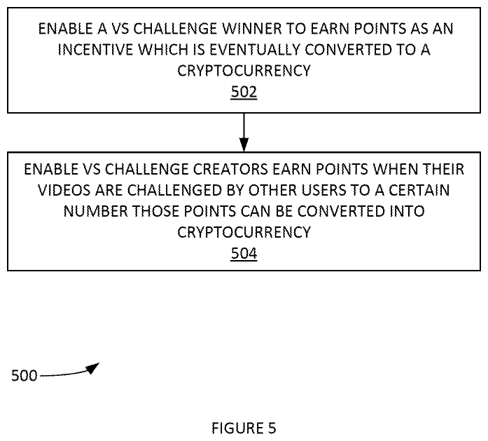

FIG. 5 illustrates an example incentivization process 500 for a cryptocurrency management in an interactive short-video platform, according to some embodiments. In step 502, process 500 can enable a Vs challenge winner to earn points as an incentive which is eventually converted to a cryptocurrency. A Vs challenge can be any type of video challenge. In step 504, process 500 can enable Vs challenge creators earn points when their videos are challenged by other users to a certain number those points can be converted into cryptocurrency. Systems 100-400 can be used to implement process 500.

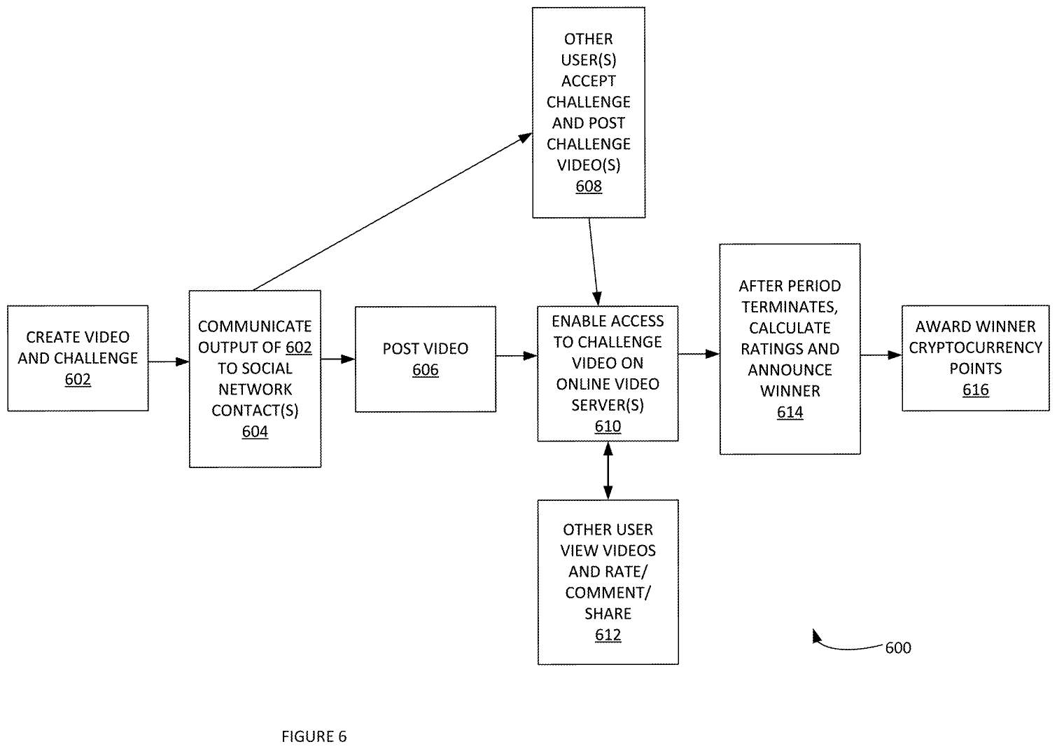

FIG. 6 illustrates can example process 600 for awarding cryptocurrency points in an interactive short-video platform, according to some embodiments. In step 602, process 600 enables a user to create video and challenge. In step 604, process 600 enables a user to communicate output of 602 to social network contact(s). This can include the challenge and various challenge details. In step 606, process 600 enables the user(s) to post video(s). In step 608, other user(s) accept challenge and post challenge video(s). In step 610, process 600 can enable access to challenge video on online video server(s). In step 612, other user(s) to view the videos and rate/comment/share with respect to the video(s).

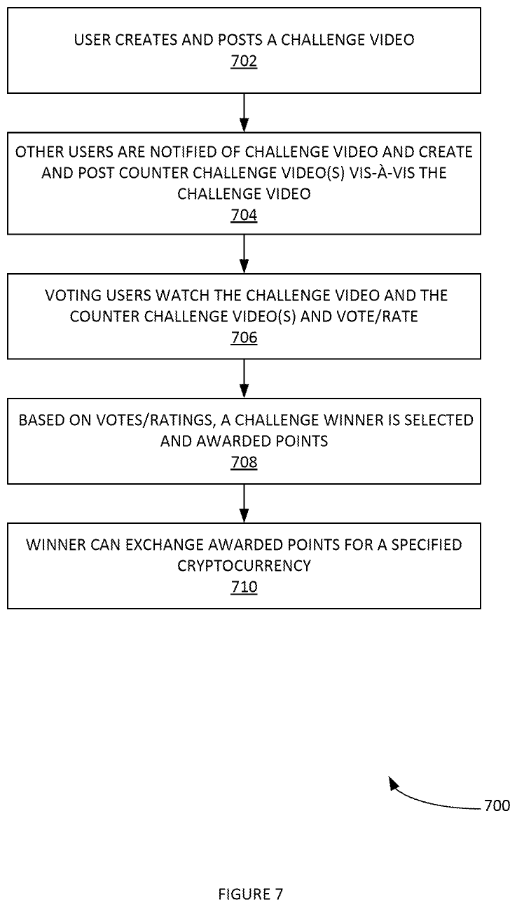

FIG. 7 illustrates an example process 700 for implementing interactive short-video, according to some embodiments. In step 702, a user creates and posts a challenge video. In step 704, other users are notified of challenge video and create and post one or more counter challenge video(s) to face off against the challenge video. In step 706, the voting users watch the challenge video and the counter challenge video(s) and vote/rate the respective videos. In step 708, based on the votes/ratings, a challenge winner is selected and process 700 awards points to the winner. Users can redeem points to cryptocurrency. The cryptocurrency can be created and managed by system 100 and/or sub elements thereof.

### Cryptocurrency Awards for Indirect Participation in an Interactive Short-Video Platform

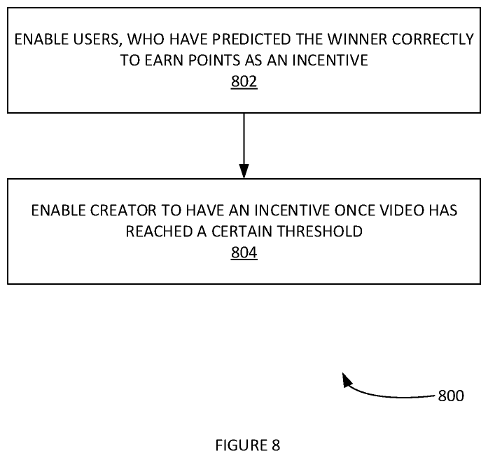

FIG. 8 illustrates an example process 800 for cryptocurrency awards for indirect participation in an interactive short-video platform, according to some embodiments. In step 802, process 800 can enable users, who have predicted the winner correctly to earn points as an incentive. In step 804, process 800 can enable the creator to also have an incentive once the video has reached a certain threshold. For example, this can include, inter alia: the number of times the video has been challenged, tinged, rating, and comments.

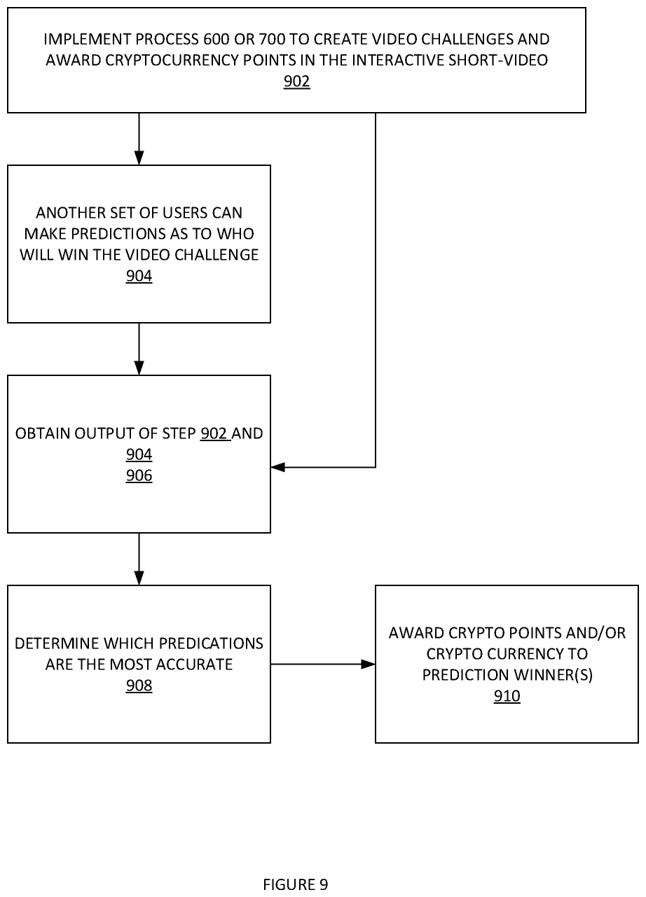

FIG. 9 illustrates another example process 900 utilized herein, according to some embodiments. Process 900 can enable initial user creates video and challenge (e.g. public, friends, etc.). Process 900 can provide that a notification is sent to friends/social network contacts of the user. Once the challenge is completed, users can explore the challenge video statistics. These can be provided via a dashboard view of the website and/or mobile application. This can be done in a profile page for example.

Other users then accept the challenge and participate on the challenge video platform with their own counter challenge videos. The counter challenge videos are posted to the short-video server. Another set of users can make predictions as to who may win the video challenge. Process 900 can enable the other set of users can also view various relevant statistics user in the profile pages. these statistics can include statistics for a cryptocurrency details, etc.

More specifically, in step 902, process 900 can implement process 600 or 700 to create video challenges and award cryptocurrency points in the interactive short-video(s). In step 902, process 900 implements process 600 or 700 to create video challenges and award cryptocurrency points in the interactive short video. In step 904, another set of users can make predictions as to who will win the video challenge. In step 906, process 900 obtains the output of step 902 and 904. In step 908, process 900 determines which predications are the most accurate. In step 910, process 900 awards crypto points and/or crypto currency to prediction winner(s).

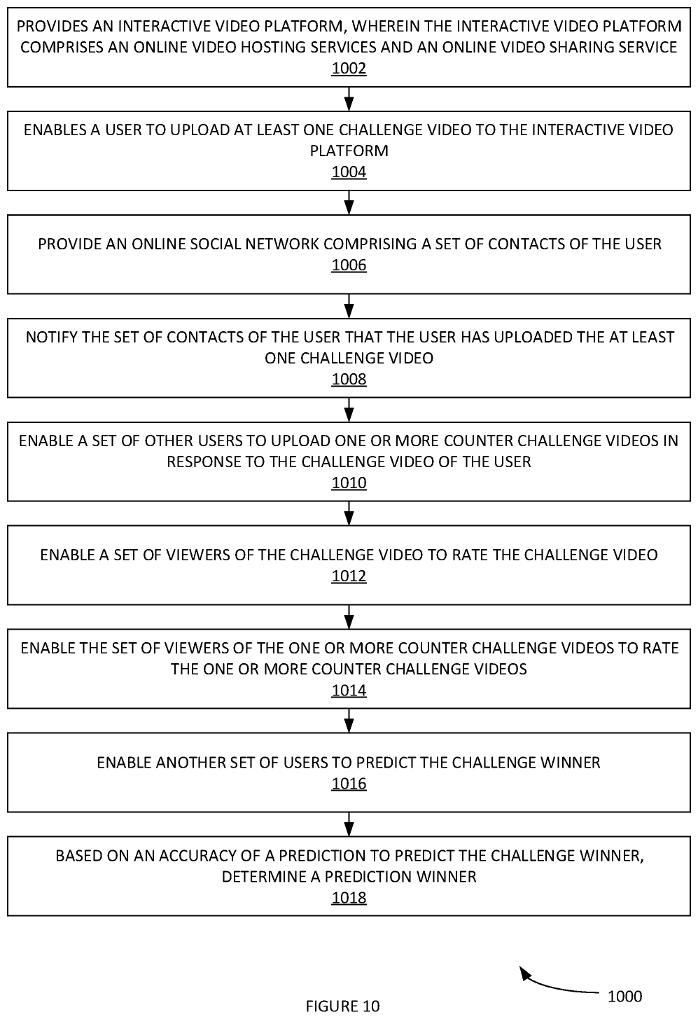

FIG. 10 illustrates an example process 1000 for implementing cryptocurrency awards for indirect participation in an interactive short-video platform, according to some embodiments. In step 1002, process 1000 provides an interactive video platform, wherein the interactive video platform comprises an online video hosting services and an online video sharing service. In step 1004, process 1000 enables a user to upload at least one challenge video to the interactive video platform. In step 1006, process 1000 provides an online social network comprising a set of contacts of the user. In step 1008, process 1000 notifies the set of contacts of the user that the user has uploaded the at least one challenge video. In step 1010, process 1000 enables a set of other users to upload one or more counter challenge videos in response to the challenge video of the user. In step 1012, process 1000 enables a set of viewers of the challenge video to rate the challenge video. In step 1014, process 1000 enables the set of viewers of the one or more counter challenge videos to rate the one or more counter challenge videos. In step 1016, process 1000 enables another set of users to predict the challenge winner. Based on an accuracy of a prediction to predict the challenge winner, in step 1018, process 1000 determines a prediction winner.

### Guessing Video Functionalities

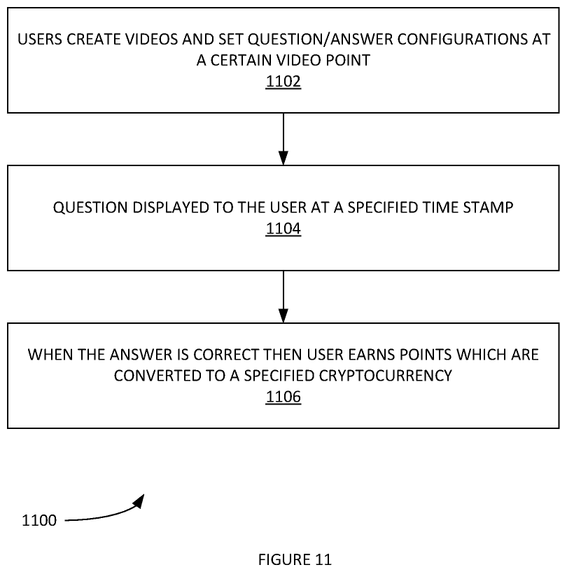

System 100 can provide a ‘guessing video’ functionality. FIG. 11 illustrates an example process 1100 for implementing a cryptocurrency awards with a guessing video functionality in an interactive short-video platform, according to some embodiments. In step 1102, users can create videos and set question/answer configurations at a certain video point (e.g. as governed by a time stamp, etc.). These videos can be the videos used in a Vs challenge discussed supra. The question can be displayed to the user at a specified time stamp in step 1104. The question can be displayed in an interactive popup window that includes input fields (e.g. text input, radio buttons, etc.). When the question pops up on video the other users can participate and guess the answer. In step 1106, when the answer is correct then user earns points (e.g. VURSE points, etc.) which are converted to a specified cryptocurrency (e.g. VURSE crypto currency, etc.).

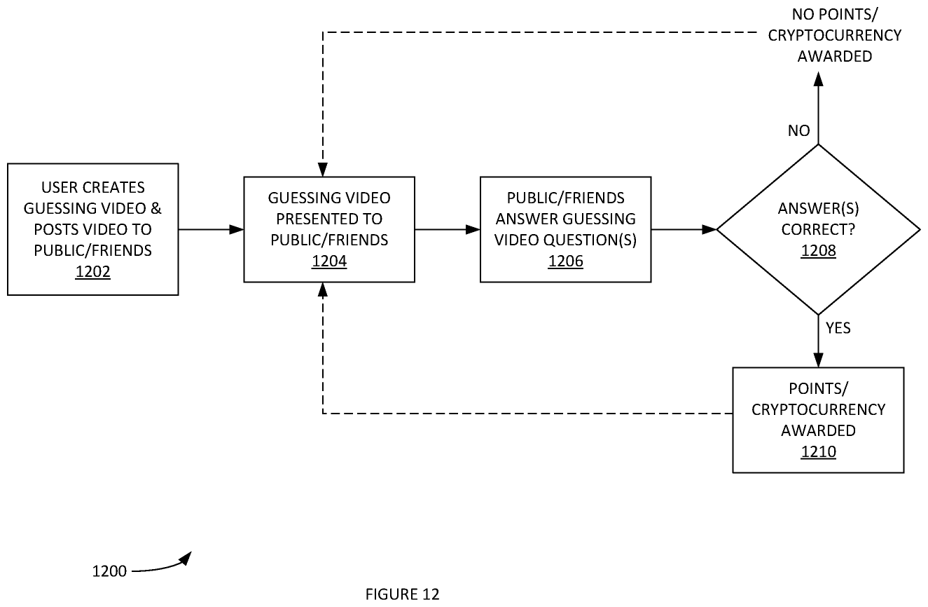

FIG. 12 illustrates another example process 1200 for managing a ‘guessing video’ functionality on a video sharing website, according to some embodiments. The video sharing website can an interactive video platform with challenge videos that awards points and/or cryptocurrency to viewers based on specified metrics. In step 1202, a user creates guessing video and posts the guessing video to public/friends on a video sharing network. The video sharing network can implement 500-1100. In step 1204, the guessing video is presented to public/friends (e.g. when viewing challenge videos, etc.). In step 1206, the public/friends answer guessing video question(s). In step 1208, it can be determined if the answer(s) are correct. If not correct, then no points/cryptocurrency are awarded. Process 1200 can return to an earlier step, such as, step 1204 for example. If the answers are correct, process 1200 awards points/cryptocurrency.

System 100 can enable a user to record a video. The user can also provide a challenge question and answers. For example, this can be the question, two options and correct answer. A timestamp for presenting the challenge questions can be provided by the user and/or automatically set by system 100. System 100 can format the video and questions for presented in the video sharing website. For example, the video then undergoes processing and submission to a video sharing website (e.g. an interactive video platform with challenge videos, etc.). It can also be stored in a database. Video sharing website users can then view the video. These can be specified social networking friends/connections and/or public users. The users are presented the questions (e.g. as written by the video creator and/or video sharing website administrators) The viewers can then answer the challenge questions. If the viewers correctly answer the challenge questions, they are awarded points. These points are stored in the database. The users can redeem points to cryptocurrency. The points and/or cryptocurrency can be stored in a blockchain. The cryptocurrency can be stored in a user's digital wallet.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for cryptocurrency management in an interactive video platform utilizing a guessing video comprising:
providing an interactive video platform, wherein the interactive video platform comprises an online video hosting services and an online video sharing service;
enabling a user to upload the guessing video to the interactive video platform, wherein the guessing video comprises a video that includes a timestamp, wherein the time stamp causes a popup display, wherein the popup display comprises a question and an input graphical user interface, and wherein a viewer enters an answer to the question using the input graphical user;
determining that the viewer has input the correct answer; and
awarding the viewer a specified number of points allotted and managed by the an online video sharing service.

2. The computerized method of claim 1, wherein the user provided the question and the correct answer when the video is uploaded.

3. The computerized method of claim 2, wherein the user specifies the timestamp when the video is uploaded.

4. The computerized method of claim 3 further comprising:
providing an online social network comprising a set of contacts of the user.

5. The computerized method of claim 4 further comprising:
notifying the set of contacts of the user that the user has uploaded the at least one guessing video.

6. The computerized method of claim 1 further comprising:
enabling a viewer winner to exchange the cryptocurrency points for a specified cryptocurrency.

7. The computerized method of claim 6, wherein the interactive video platform comprises an interactive short-video platform.

8. The computerized method of claim 7, wherein the interactive short-video platform creates the specified cryptocurrency.

9. The computerized method of claim 8, wherein the set of other users comprises a set of social network contacts of the user.

10. The computerized method of claim 5, wherein the social network contacts are in an online social network managed by the interactive short-video platform.

11. The computerized method of claim 7 further comprising:
awarding the guessing winner plurality of cryptocurrency points.

12. The computerized method of claim 11 further comprising:
enabling the guessing winner to exchange the cryptocurrency points for a specified cryptocurrency.

13. The computerized method of claim 12 further comprising:
enabling a set of other users to upload one or more counter challenge videos in response to the challenge video of the user;
enabling a set of viewers of the challenge video to rate the challenge video;
enabling the set of viewers of the one or more counter challenge videos to rate the one or more counter challenge videos;
enabling another set of users to predict the challenge winner; and
based on an accuracy of a prediction to predict the challenge winner, determining a prediction winner.
